(19) United States
(12) Patent Application Publication
(10) Pub. No.: US 2023/0386096 A1
(43) Pub. Date: Nov. 30, 2023

(54) SERVER APPARATUS, SYSTEM, AND OPERATING METHOD OF SYSTEM

(71) Applicant: TOYOTA JIDOSHA KABUSHIKI KAISHA, Toyota-shi (JP)

(72) Inventor: Wataru KAKU, Musashino-shi (JP)

(73) Assignee: TOYOTA JIDOSHA KABUSHIKI KAISHA, Toyota-shi (JP)

(21) Appl. No.: 18/322,196

(22) Filed: May 23, 2023

(30) Foreign Application Priority Data
May 24, 2022 (JP) 2022-084670

(51) Int. Cl. G06T 11/00

(52) U.S. Cl. CPC G06T 11/00

(57) ABSTRACT

A server apparatus includes a communication interface and a controller configured to communicate using the communication interface. The controller is configured to receive mode information from a terminal apparatus of each user among a plurality of users in a virtual event, the mode information indicating a participation mode of the user, and based on the mode information, transmit information to the terminal apparatus for generating an image of the virtual event in which an image of each user is placed at a position with a priority corresponding to the participation mode of the user.

### CROSS-REFERENCE TO RELATED APPLICATION

This application claims priority to Japanese Patent Application No. 2022-084670, filed on May 24, 2022, the entire contents of which are incorporated herein by reference.

### TECHNICAL FIELD

The present disclosure relates to a server apparatus, a system, and an operating method of a system.

### BACKGROUND

A method is known for computers at multiple points to communicate via a network and hold virtual events, such as meetings, in a virtual space on the network. Various technologies have been proposed to support smooth communication among users in such virtual events. For example, Patent Literature (PTL) 1 discloses a system that corrects the image of the calling party, displayed on each user's computer, to the camera's viewpoint.

### CITATION LIST

### Patent Literature

PTL 1: JP 6849133 B2

### SUMMARY

Communication among users participating in virtual events on a network could be facilitated to improve the user experience.

The present disclosure provides a server apparatus and the like that contribute to improving the user experience for users participating in virtual events.

A server apparatus according to the present disclosure includes:
a communication interface; and
a controller configured to communicate using the communication interface, wherein
the controller is configured to receive mode information from a terminal apparatus of each user among a plurality of users in a virtual event, the mode information indicating a participation mode of the user, and based on the mode information, transmit information to the terminal apparatus for generating an image of the virtual event in which an image of each user is placed at a position with a priority corresponding to the participation mode of the user.

A system according to the present disclosure is a system including a server apparatus and a terminal apparatus configured to communicate with each other, wherein
the terminal apparatus is configured to transmit, to the server apparatus, mode information indicating a participation mode for each user among a plurality of users in a virtual event, and
the server apparatus is configured to transmit, based on the mode information, information to the terminal apparatus for generating an image of the virtual event in which an image of each user is placed at a position with a priority corresponding to the participation mode of the user.

An operating method of a system according to the present disclosure is an operating method of a system including a server apparatus and a terminal apparatus configured to communicate with each other, the operating method including:
transmitting, by the terminal apparatus to the server apparatus, mode information indicating a participation mode for each user among a plurality of users in a virtual event; and
transmitting, by the server apparatus based on the mode information, information to the terminal apparatus for generating an image of the virtual event in which an image of each user is placed at a position with a priority corresponding to the participation mode of the user.

The terminal apparatus and the like according to the present disclosure can contribute to improving the user experience for users participating in virtual events.

### BRIEF DESCRIPTION OF THE DRAWINGS

In the accompanying drawings:

FIG. 1 is a diagram illustrating an example configuration of a virtual event provision system;

FIG. 2 is a sequence diagram illustrating an example of operations of the virtual event provision system;

FIG. 3A is a flowchart illustrating an example of operations of a terminal apparatus;

FIG. 3B is a flowchart illustrating an example of operations of a server apparatus;

FIG. 3C is a flowchart illustrating an example of operations of a terminal apparatus;

FIG. 4A is a diagram illustrating an example of a virtual event image;

FIG. 4B is a diagram illustrating an example of a virtual event image;

FIG. 4C is a diagram illustrating an example of a virtual event image; and

FIG. 4D is a diagram illustrating an example of a virtual event image.

### DETAILED DESCRIPTION

### Embodiments are Described Below

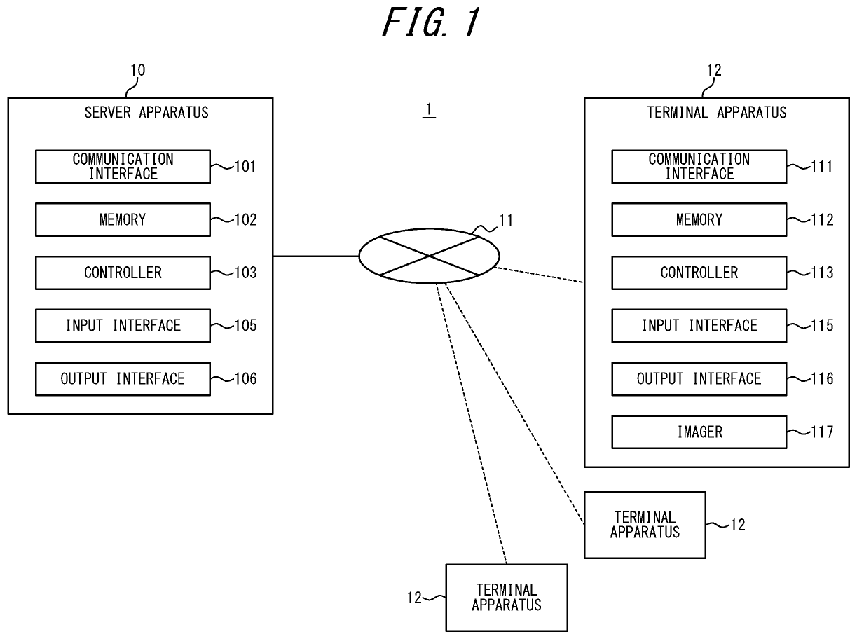

FIG. 1 is a diagram illustrating an example configuration of a virtual event provision system in an embodiment. The virtual event provision system 1 includes a plurality of terminal apparatuses 12 and a server apparatus 10 that are communicably connected to each other via a network 11. The virtual event provision system 1 is a system for providing events in a virtual space, i.e., virtual events, in which users can participate using the terminal apparatuses 12. A virtual event is an event in which a plurality of participants communicates information by speech or the like in a virtual space, and each participant is represented by a user image such as a 2D image or a 3D model. The virtual event in the present embodiment is a discussion among participants on any topic.

The server apparatus 10 is, for example, a server computer that belongs to a cloud computing system or other computing system and functions as a server that implements various functions. The server apparatus 10 may be configured by two or more server computers that are communicably connected to each other and operate in cooperation. The server apparatus 10 transmits and receives, and executes information processing on, information necessary to provide virtual events.

Each terminal apparatus 12 is an information processing apparatus provided with communication functions and is used by a user (participant) who participates in a virtual event provided by the server apparatus 10. The terminal apparatus 12 is, for example, an information processing terminal, such as a smartphone or a tablet terminal, or an information processing apparatus, such as a personal computer.

The network 11 may, for example, be the Internet or may include an ad hoc network, a local area network (LAN), a metropolitan area network (MAN), other networks, or any combination thereof.

In the present embodiment, the server apparatus 10 includes a communication interface 101 and a controller 103 that communicates using the communication interface 101. The controller 103 receives mode information from the terminal apparatus 12 of each user among a plurality of users in a virtual event, the mode information indicating a participation mode of the user, and based on the mode information, transmits information to the terminal apparatus 12 for generating an image of the virtual event (virtual event image) in which an image of each user (user image) is placed at a position with a priority corresponding to the participation mode of the user. The participation mode includes attention by each user to the user images of other users in the virtual event image, and the controller 103 determines the priority according to the amount of attention from other users. In other words, as the amount of attention a user receives from other users is greater, that user's user image is placed at a position with higher priority. Alternatively, the participation mode includes speech by each user in the virtual event, and the controller 103 determines the priority according to an amount of speech by each user. In other words, as the amount of speech by a user is greater, that user's user image is placed at a position with higher priority. The terminal apparatus 12 displays the virtual event image configured in this manner to the user. Each user can communicate by looking at the virtual event image in which users paid the most attention or users with the largest amount of speech are placed at positions of high priority, such as at the center of the image. Thus, communication can be intuitively focused on the dominant user in terms of attention or conversation, which can facilitate communication and improve the user experience.

Respective configurations of the server apparatus 10 and the terminal apparatuses 12 are described in detail.

The server apparatus 10 includes a communication interface 101, a memory 102, a controller 103, an input interface 105, and an output interface 106. These configurations are appropriately arranged on two or more computers in a case in which the server apparatus 10 is configured by two or more server computers.

The communication interface 101 includes one or more interfaces for communication. The interface for communication is, for example, a LAN interface. The communication interface 101 receives information to be used for the operations of the server apparatus 10 and transmits information obtained by the operations of the server apparatus 10. The server apparatus 10 is connected to the network 11 by the communication interface 101 and communicates information with the terminal apparatuses 12 via the network 11.

The memory 102 includes, for example, one or more semiconductor memories, one or more magnetic memories, one or more optical memories, or a combination of at least two of these types, to function as main memory, auxiliary memory, or cache memory. The semiconductor memory is, for example, Random Access Memory (RAM) or Read Only Memory (ROM). The RAM is, for example, Static RAM (SRAM) or Dynamic RAM (DRAM). The ROM is, for example, Electrically Erasable Programmable ROM (EEPROM). The memory 102 stores information to be used for the operations of the server apparatus 10 and information obtained by the operations of the server apparatus 10.

The controller 103 includes one or more processors, one or more dedicated circuits, or a combination thereof. The processor is a general purpose processor, such as a central processing unit (CPU), or a dedicated processor, such as a graphics processing unit (GPU), specialized for a particular process. The dedicated circuit is, for example, a field-programmable gate array (FPGA), an application specific integrated circuit (ASIC), or the like. The controller 103 executes information processing related to operations of the server apparatus 10 while controlling components of the server apparatus 10.

The input interface 105 includes one or more interfaces for input. The interface for input is, for example, a physical key, a capacitive key, a pointing device, a touch screen integrally provided with a display, or a microphone that receives audio input. The input interface 105 accepts operations to input information used for operation of the server apparatus 10 and transmits the inputted information to the controller 103.

The output interface 106 includes one or more interfaces for output. The interface for output is, for example, a display or a speaker. The display is, for example, a liquid crystal display (LCD) or an organic electro-luminescent (EL) display. The output interface 106 outputs information obtained by the operations of the server apparatus 10.

The functions of the server apparatus 10 are realized by a processor included in the controller 103 executing a control program. The control program is a program for causing a computer to function as the server apparatus 10. Some or all of the functions of the server apparatus 10 may be realized by a dedicated circuit included in the controller 103. The control program may be stored on a non-transitory recording/storage medium readable by the server apparatus 10 and be read from the medium by the server apparatus 10.

Each terminal apparatus 12 includes a communication interface 111, a memory 112, a controller 113, an input interface 115, an output interface 116, and an imager 117.

The communication interface 111 includes a communication module compliant with a wired or wireless LAN standard, a module compliant with a mobile communication standard such as LTE, 4G, or 5G, or the like. The terminal apparatus 12 connects to the network 11 via a nearby router apparatus or mobile communication base station using the communication interface 111 and communicates information with the server apparatus 10 and the like over the network 11.

The memory 112 includes, for example, one or more semiconductor memories, one or more magnetic memories, one or more optical memories, or a combination of at least two of these types. The semiconductor memory is, for example, RAM or ROM. The RAM is, for example, SRAM or DRAM. The ROM is, for example, EEPROM. The memory 112 functions as, for example, a main memory, an auxiliary memory, or a cache memory. The memory 112 stores information to be used for the operations of the controller 113 and information obtained by the operations of the controller 113.

The controller 113 has one or more general purpose processors, such as CPUs or Micro Processing Units (MPUs), or one or more dedicated processors, such as GPUs, that are dedicated to specific processing. Alternatively, the controller 113 may have one or more dedicated circuits such as FPGAs or ASICs. The controller 113 is configured to perform overall control of the operations of the terminal apparatus 12 by operating according to the control/processing programs or operating according to operation procedures implemented in the form of circuits. The controller 113 then transmits and receives various types of information to and from the server apparatus 10 and the like via the communication interface 111 and executes the operations according to the present embodiment.

The input interface 115 includes one or more interfaces for input. The interface for input may include, for example, a physical key, a capacitive key, a pointing device, and/or a touch screen integrally provided with a display. The interface for input may also include a microphone that accepts audio input and a camera that captures images. The interface for input may further include a scanner, camera, or IC card reader that scans an image code. The input interface 115 accepts operations for inputting information to be used in the operations of the controller 113 and transmits the inputted information to the controller 113.

The output interface 116 includes one or more interfaces for output. The interface for output may include, for example, a display or a speaker. The display is, for example, an LCD or an organic EL display. The output interface 116 outputs information obtained by the operations of the controller 113.

The imager 117 includes a camera that captures an image of a subject using visible light and a distance measuring sensor that measures the distance to the subject to acquire a distance image. The camera captures a subject at, for example, 15 to 30 frames per second to produce a moving image formed by a series of captured images. Distance measurement sensors include ToF (Time Of Flight) cameras, LiDAR (Light Detection And Ranging), and stereo cameras and generate distance images of a subject that contain distance information. The imager 117 transmits the captured images and the distance images to the controller 113.

The functions of the controller 113 are realized by a processor included in the controller 113 executing a control program. The control program is a program for causing the processor to function as the controller 113. Some or all of the functions of the controller 113 may be realized by a dedicated circuit included in the controller 113. The control program may be stored on a non-transitory recording/storage medium readable by the terminal apparatus 12 and be read from the medium by the terminal apparatus 12.

In the present embodiment, the controller 113 acquires a captured image and a distance image of the user of the terminal apparatus 12 with the imager 117 and collects audio of the speech of the user with the microphone of the input interface 115. The controller 113 encodes the captured image and distance image of the user, which are for generating the user image, and audio information, which is for reproducing the user's speech, to generate encoded information. The controller 113 may perform any appropriate processing (such as resolution change and trimming) on the captured images and the like at the time of encoding. The controller 113 uses the communication interface 111 to transmit the encoded information to the other terminal apparatus 12 via the server apparatus 10. The controller 113 also receives encoded information, transmitted from the other terminal apparatus 12 via the server apparatus 10, using the communication interface 111. Upon decoding the encoded information received from the other terminal apparatus 12, the controller 113 uses the decoded information to generate a user image representing the user who uses the other terminal apparatus 12 and places the user image, together with the user image of the user corresponding to the controller 113, in the virtual space. When the controller 113 generates a virtual space image, i.e. a virtual event image, for output by rendering, the virtual event image including a user image from a predetermined viewpoint in the virtual space, the output interface 116 displays the virtual event image and outputs speech based on audio information for each user. These operations of the controller 113 and the like enable the user of the terminal apparatus 12 to participate in the virtual event and talk with other users in real time.

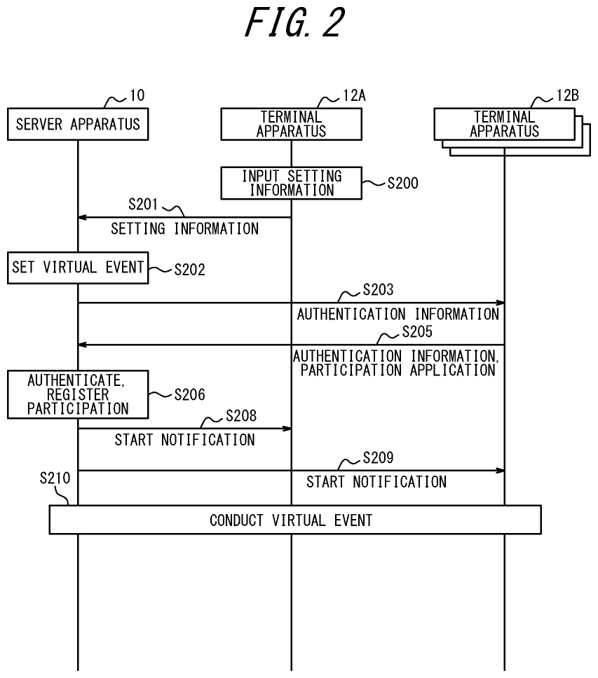

FIG. 2 is a sequence diagram illustrating the operating procedures of the virtual event provision system 1. This sequence diagram illustrates the steps in the coordinated operation of the server apparatus 10 and the plurality of terminal apparatuses 12 (referred to as the terminal apparatus 12A and 12B when distinguishing therebetween). The terminal apparatus 12A is used by a user who is the administrator of the virtual event. A plurality of terminal apparatuses 12B are used by users other than the administrator. The operating procedures illustrated here for the terminal apparatuses 12B are executed by each terminal apparatus 12B or by each terminal apparatus 12B and the server apparatus 10.

The steps pertaining to the various information processing by the server apparatus 10 and the terminal apparatuses 12 in FIG. 2 are executed by the respective controllers 103 and 113. The steps pertaining to transmitting and receiving various types of information to and from the server apparatus 10 and the terminal apparatuses 12 are executed by the respective controllers 103 and 113 transmitting and receiving information to and from each other via the respective communication interfaces 101 and 111. In the server apparatus 10 and the terminal apparatuses 12, the respective controllers 103 and 113 appropriately store the information that is transmitted and received in the respective memories 102 and 112. Furthermore, the controller 113 of the terminal apparatus 12 accepts input of various types of information with the input interface 115 and outputs various types of information with the output interface 116.

In step S200, the terminal apparatus 12A accepts input of virtual event setting information by the administrative user. The setting information includes the schedule of the virtual event, the topic for discussion, a list of participants, and the like. The list of participants includes each participant's name and email address. In step S201, the terminal apparatus 12A then transmits the setting information to the server apparatus 10. The server apparatus 10 receives the information transmitted from the terminal apparatus 12A. For example, the terminal apparatus 12A accesses a site provided by the server apparatus 10 for conducting a virtual event, acquires an input screen for setting information, and displays the input screen. Then, once the administrative user inputs the setting information on the input screen, the setting information is transmitted to the server apparatus 10.

In step S202, the server apparatus 10 sets up a virtual event based on the setting information. The controller 103 stores information on the virtual event and information on the expected participants in association in the memory 102.

In step S203, the server apparatus 10 transmits authentication information to each terminal apparatus 12B. The authentication information is information used to identify and authenticate a user who uses the terminal apparatus 12B, i.e., information such as an ID and passcode used when participating in a virtual event. Such information is, for example, transmitted as an e-mail attachment. The terminal apparatus 12B receives the information transmitted from the server apparatus 10.

In step S205, the terminal apparatus 12B transmits the authentication information received from the server apparatus 10 and information on a participation application to the server apparatus 10. The user of the terminal apparatus 12B operates the terminal apparatus 12B and applies to participate in the virtual event using the authentication information transmitted by the server apparatus 10. For example, the terminal apparatus 12B accesses the site provided by the server apparatus 10 for the virtual event, acquires the input screen for the authentication information and the information on the participation application, and displays the input screen to the user. The terminal apparatus 12B then accepts the information inputted by the user and transmits the information to the server apparatus 10.

In step S206, the server apparatus 10 performs authentication on the user, thereby completing registration for participation. The identification information for the terminal apparatus 12B and the identification information for the user are stored in association in the memory 102.

In steps S208 and S209, the server apparatus 10 transmits a virtual event start notification to the terminal apparatuses 12A and 12B. Upon receiving the information transmitted from the server apparatus 10, the terminal apparatuses 12A and 12B begin the imaging and collection of audio of speech for the respective users.

In step S210, a virtual event is conducted by the terminal apparatuses 12A and 12B via the server apparatus 10. The terminal apparatuses 12 transmit and receive information for generating the respective user images and information on speech to each other via the server apparatus 10. Each terminal apparatus 12 also outputs virtual event images, including user images of the user of the terminal apparatus 12 and other users, along with other users' speech to the user.

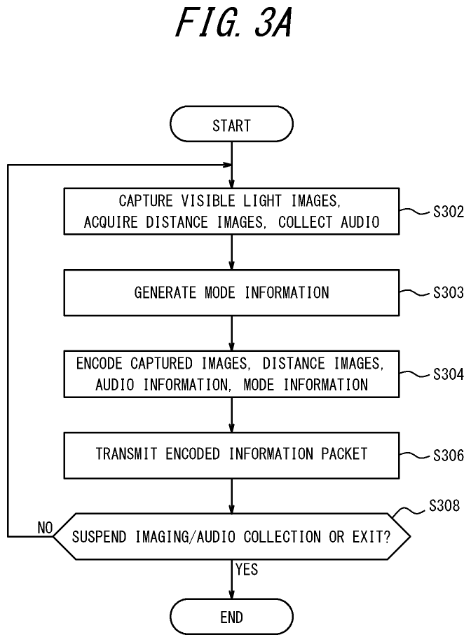

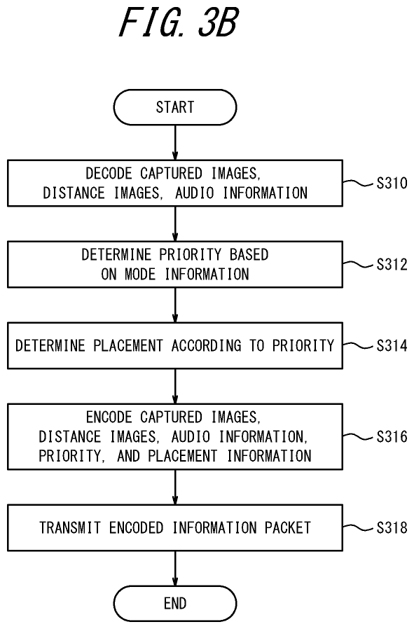

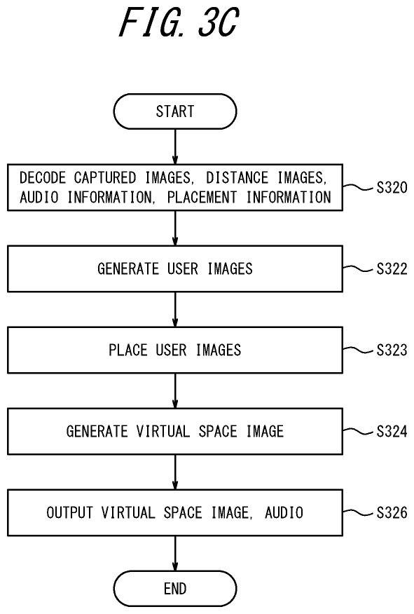

FIGS. 3A to 3C illustrate the operating procedures for the server apparatus 10 and the terminal apparatus 12 for conducting a virtual event. FIGS. 3A and 3C are flowcharts illustrating an example of operating procedures for the terminal apparatus 12. FIG. 3B is a flowchart illustrating an example of operating procedures for the server apparatus 10.

FIG. 3A relates to the operating procedures for the controller 113 when each terminal apparatus 12 transmits information for generating a user image of the user who uses that terminal apparatus 12.

In step S302, the controller 113 captures visible light images and acquires distance images of the participant at an appropriately set frame rate using the imager 117 and collects audio of the participant's speech using the input interface 115. The controller 113 acquires the images captured by visible light and the distance images from the imager 117 and the audio information from the input interface 115.

In step S303, the controller 113 generates mode information using the captured image, the distance image, and the audio information.

The mode information is, for example, information that identifies the user images of other users to which the user pays attention. By executing the procedure in FIG. 3C, described below, the terminal apparatus 12 displays the virtual event image to the user. The virtual event image includes user images respectively indicating the user of the terminal apparatus 12 and the users of other terminal apparatuses 12. The controller 113 identifies the user image that the user corresponding to the controller 113 pays attention to in the virtual event image. For example, the controller 113 performs image processing using a captured image and distance image of the user to detect the user's point of regard in the virtual event image. The controller 113 uses information such as the position of the user image in the virtual event image, the position of the display on which the virtual event image is displayed and of the camera, and the distance from the display and the camera to the position of the user's eyes to detect the user's point of regard and identify the user image of another user corresponding to the point of regard.

The mode information is, for example, information on the amount of speech by the user. The amount of speech is, for example, the total speaking time during the most recent determination period (for example, several seconds to several minutes). The controller 113 detects sounds that are in the frequency band to which human speech sounds belong (for example, 100 Hz to 1000 Hz) and are above an appropriate reference sound pressure as speech. The controller 113 may distinguish speech that matches a preset language from other noise through speech recognition. The controller 113 derives the amount of speech by accumulating the time that speech is detected during the determination period.

In step S304, the controller 113 encodes the captured image, the distance image, the audio information, and the mode information to generate encoded information.

In step S306, the controller 113 converts the encoded information into packets using the communication interface 111 and transmits the packets to the server apparatus 10 for the other terminal apparatuses 12.

When information inputted for an operation by the user to suspend imaging and collection of audio or to exit the virtual event is acquired (Yes in S308), the controller 113 terminates the processing procedure in FIG. 3A, whereas while not acquiring information corresponding to an operation to suspend or exit (No in S308), the controller 113 executes steps S302 to S306 and transmits, to the server apparatus 10 for the other terminal apparatuses 12, information for generating a user image and information for outputting audio together with the mode information.

FIG. 3B relates to the operating procedures for the controller 103 when the server apparatus 10 relays information transmitted by the terminal apparatus 12. Upon receiving a packet transmitted by the terminal apparatus 12 executing the procedures in FIG. 3A, the controller 103 executes steps S310 to S318.

In step S310, the controller 103 decodes the encoded information included in the packet received from the terminal apparatus 12 to acquire the captured image, distance image, audio information, and mode information.

In step S312, the controller 103 determines the priority of the user images based on the mode information. For example, for each terminal apparatus 12, the controller 103 derives the other user image to which each user is paying attention. The controller 103 then aggregates the number of other users paying attention to each user image and determines the priority in order of the aggregate result, i.e., in order of the amount of attention. As another example, the controller 103 determines the priority for user images indicating users of a plurality of terminal apparatuses 12 in order of the amount of speech. In this way, the controller 103 determines the priority for the user images of users participating in the virtual event according to the amount of attention or amount of speech. In other words, as a user receives more attention from other users in a virtual event or is more dominant in a conversation with other users, the user image for the user is assigned a higher priority.

In step S314, the controller 103 determines the placement of each user image in the event image according to their respective priorities. The placement according to priority is determined based on rules set freely in advance. For example, the controller 103 determines the placement of the user images so that as the priority of a user image is higher, the user image is closer to the center of the virtual event image. The controller 103 may also determine the placement of the user images so that as the priority of a user image is higher, the user image is closer to the top of the virtual event image. In such cases, user images are, for example, placed to form a hierarchy according to priority.

In step S316, the controller 103 encodes the captured image, the distance image, the audio information, and placement information for the user image to generate encoded information.

In step S318, the controller 103 converts the encoded information into packets using the communication interface 101 and transmits the packets to the other terminal apparatuses 12.

FIG. 3C relates to the operating procedures of the controller 113 when the terminal apparatus 12 outputs an image of the virtual event and audio of other users. Upon receiving, via the server apparatus 10 that executes the procedures of FIG. 3B, a packet transmitted by the other terminal apparatus 12 executing the procedures in FIG. 3A, the controller 113 executes steps S320 to S323.

In step S320, the controller 113 decodes the encoded information included in the packet received from another terminal apparatus 12 to acquire the captured image, distance image, audio information, and positional information. When executing step S302, the controller 113 acquires the captured image and distance image of the user corresponding to the controller 113 from the imager 117 and the audio information from the input interface 115.

In step S322, the controller 113 generates user images of the corresponding user and other users based on the captured images and the distance images. The user images are, for example, 2D images of each user's face, upper body, or the like; 3D models; character images yielded by converting captured images by any appropriate algorithm; or the like.

In the case of receiving information from terminal apparatuses 12 of a plurality of users, the controller 113 executes steps S320 to S322 for each terminal apparatus 12 to generate the user image for each user.

In step S323, the controller 113 places each user image in the virtual space where the virtual event is held. The memory 112 stores, in advance, information on the coordinates of the virtual space and the coordinates at which each user image should initially be placed according to the order of authentication, for example. In a case of acquiring positional information generated on the server apparatus 10, the controller 113 places each user image based on the placement information.

In step S324, the controller 113 renders and generates a virtual space image in which the plurality of user images placed in the virtual space are captured from a virtual viewpoint.

In step S326, the controller 113 displays the virtual space image, i.e., the virtual event image, and outputs speech using the output interface 116. In other words, the controller 113 outputs information to the output interface 116 for displaying virtual event images, and the output interface 116 displays the virtual event images and outputs speech.

By the controller 113 repeatedly executing steps S320 to S326, the user can listen to the speech of other users while watching a video of virtual event images that include user images of the user and other users. At that time, each user image is displayed at a placement according to the participation mode.

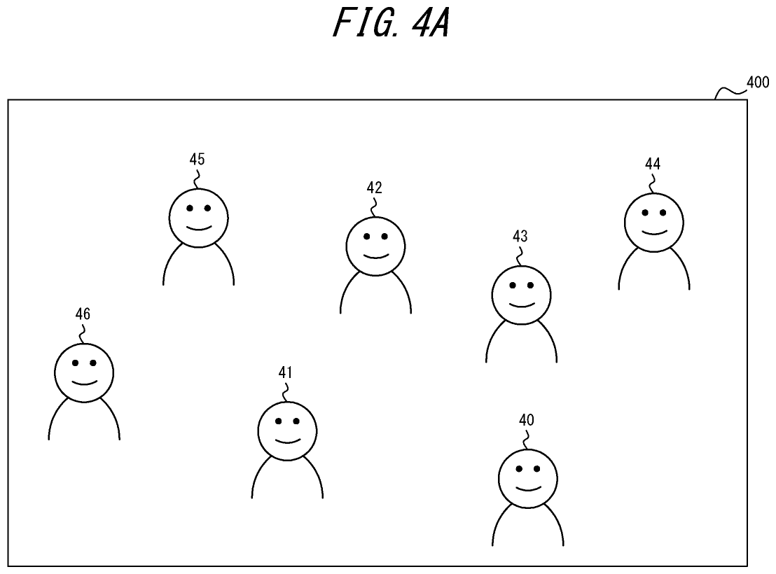

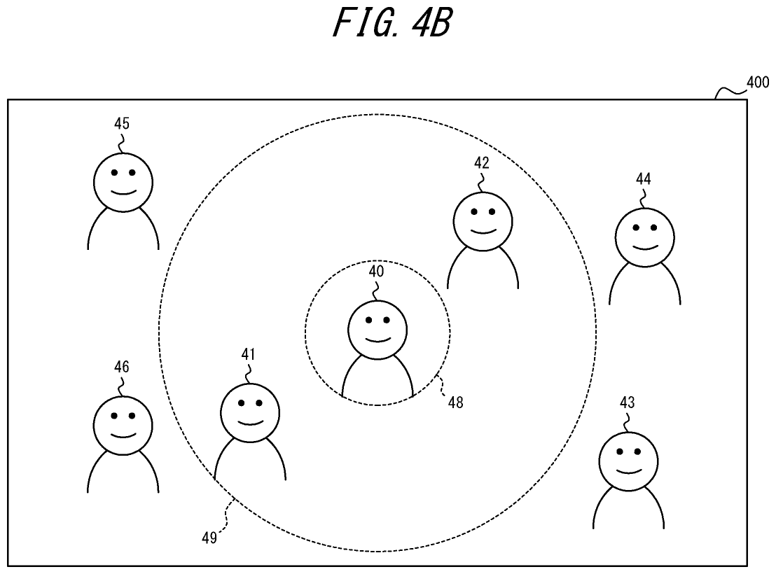

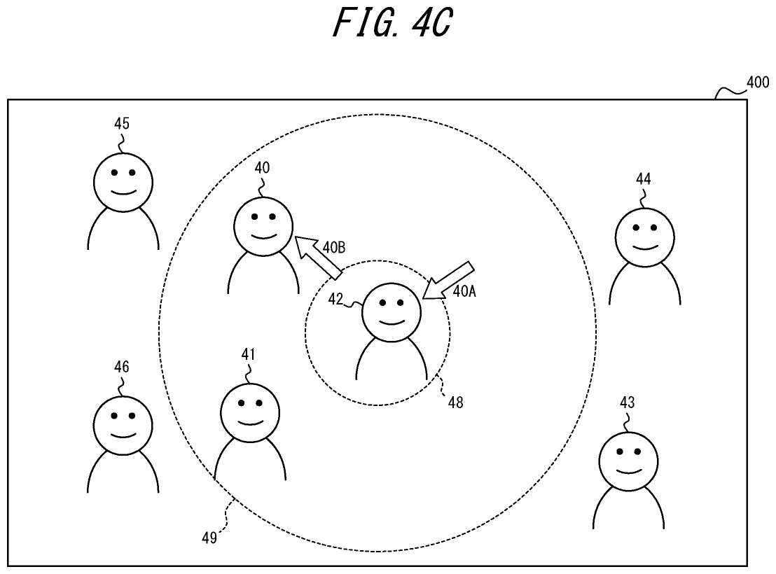

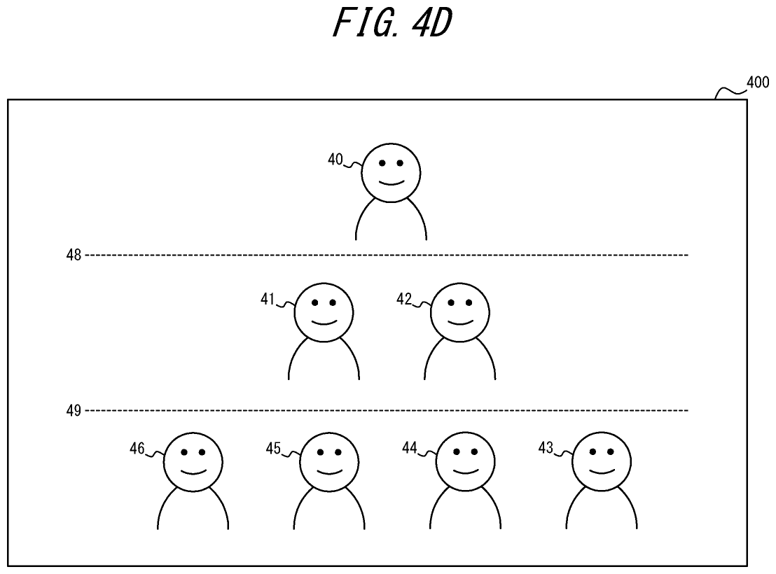

FIGS. 4A to 4D illustrate examples of virtual event images displayed by the terminal apparatus 12.

FIG. 4A is an example of a virtual event image 400 with user images 40 to 46 initially placed.

FIG. 4B is an example of a virtual event image 400 in which user images 40 to 46 are placed based on placement information. Here, the user image 40 of the most dominant user in terms of gathering attention or in a conversation is placed inside the highest priority central area, i.e., a boundary 48. The user images 41 and 42 of the next-most dominant users are placed on the periphery of the central area, i.e., between boundaries 48 and 49. The user images 43, 44, 45, 46 of the least dominant users are then placed outside the boundary 49. This placement enables users viewing the virtual event image 400 to intuitively focus on the user image of the user who is dominant in terms of gathering attention or in a conversation, thereby facilitating smooth communication.

FIG. 4C is an example of a virtual event image 400 for a case in which the user who is dominant in terms of gathering attention or in a conversation changes as each user's participation mode changes. FIG. 4C illustrates an example of a case in which the user corresponding to the user image 42 becomes more dominant than the user corresponding to the user image 40, who was the most dominant in FIG. 4B, so that the user images 40 and 42 are swapped accordingly. In the case illustrated here, the user image 40 moves from inside to outside the boundary 48 of the central area (arrow 40B), and the user image 42 moves from outside to inside the boundary 48 (arrow 40A). This dynamic change in the placement of user images in response to changes in the participation mode of each user enables users viewing the virtual event image 400 to intuitively grasp changes in the user who is dominant in terms of gathering attention or in a conversation.

FIG. 4D is an example of a virtual event image 400 in which user images 40 to 46 are placed in a different manner based on placement information. Here, the user image 40 of the most dominant user in terms of attention or in a conversation is placed in the highest priority top layer, i.e., above the boundary 48. The user images 41 and 42 of the next-most dominant users are placed in the middle layer, i.e., between boundaries 48 and 49. The user images 43, 44, 45, 46 of the least dominant users are then placed in the lowest layer, i.e., below the boundary 49. Even with this placement, users viewing the virtual event image 400 can intuitively focus on the user image of the user who is dominant in terms of gathering attention or in a conversation, thereby facilitating smooth communication.

As a variation, instead of the terminal apparatus 12 executing step S303 in FIG. 3A, the server apparatus 10 in FIG. 3B may generate the mode information based on the captured image or audio information for each terminal apparatus 12 after step S310.

Furthermore, the case of the priority for determining the placement of user images being determined based on the amount of attention from other users and the amount of speech is also included in the present embodiment. For example, the server apparatus 10 or the terminal apparatus 12 can normalize the amount of attention and the amount of speech to any appropriate score and determine the priority in the order of the total score. Alternatively, the scores for the amount of attention and amount of speech may each be given a freely set weight, and the total may be calculated.

An example of the placement of user images being divided into three levels has been described, but the number of levels is not limited to this example.

While embodiments have been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. A server apparatus comprising:
a communication interface; and
a controller configured to communicate using the communication interface, wherein
the controller is configured to receive mode information from a terminal apparatus of each user among a plurality of users in a virtual event, the mode information indicating a participation mode of the user, and based on the mode information, transmit information to the terminal apparatus for generating an image of the virtual event in which an image of each user is placed at a position with a priority corresponding to the participation mode of the user.

2. The server apparatus according to claim 1, wherein
the participation mode includes attention by each user to images of other users in the image of the virtual event, and
the controller is configured to determine the priority according to an amount of attention from other users.

3. The server apparatus according to claim 1, wherein
the participation mode includes speech by each user in the virtual event, and
the controller is configured to determine the priority according to an amount of speech by each user.

4. The server apparatus according to claim 1, wherein the controller is configured to change the priority of the image of each user according to the mode information during the virtual event and transmit information to the terminal apparatus for generating the image of the virtual event in correspondence with the changed priority.

5. A system comprising a server apparatus and a terminal apparatus configured to communicate with each other, wherein
the terminal apparatus is configured to transmit, to the server apparatus, mode information indicating a participation mode for each user among a plurality of users in a virtual event, and
the server apparatus is configured to transmit, based on the mode information, information to the terminal apparatus for generating an image of the virtual event in which an image of each user is placed at a position with a priority corresponding to the participation mode of the user.

6. The system according to claim 5, wherein the participation mode includes attention by each user to images of other users in the image of the virtual event, and the priority is determined according to an amount of attention from other users.

7. The system according to claim 5, wherein the participation mode includes speech by each user in the virtual event, and the priority is determined according to an amount of speech by each user.

8. The system according to claim 5, wherein
the server apparatus or the terminal apparatus is configured to change the priority of the image of each user according to the mode information during the virtual event, and
the terminal apparatus is configured to output the image of the virtual event based on information for generating the image of the virtual event in correspondence with the changed priority.

9. An operating method of a system comprising a server apparatus and a terminal apparatus configured to communicate with each other, the operating method comprising:
transmitting, by the terminal apparatus to the server apparatus, mode information indicating a participation mode for each user among a plurality of users in a virtual event; and
transmitting, by the server apparatus based on the mode information, information to the terminal apparatus for generating an image of the virtual event in which an image of each user is placed at a position with a priority corresponding to the participation mode of the user.

10. The operating method according to claim 9, wherein the participation mode includes attention by each user to images of other users in the image of the virtual event, and the priority is determined according to an amount of attention from other users.

11. The operating method according to claim 9, wherein
the participation mode includes speech by each user in the virtual event, and the priority is determined according to an amount of speech by each user.

12. The operating method according to claim 9, further comprising:
changing, by the server apparatus or the terminal apparatus, the priority of the image of each user according to the mode information during the virtual event; and
outputting, by the terminal apparatus, the image of the virtual event based on information for generating the image of the virtual event in correspondence with the changed priority.
